(19) United States
(12) Patent Application Publication
(10) Pub. No.: US 2009/0212014 A1
(43) Pub. Date: Aug. 27, 2009

(54) METHOD AND SYSTEM FOR PERFORMING MULTIPLE TREATMENTS IN A DUAL-CHAMBER BATCH PROCESSING SYSTEM

(75) Inventor: Mitsunori Ohata, Nirasaki-shi (JP)

Correspondence Address: Tokyo Electron U.S. Holdings, Inc., 4350 West Chandler Blvd., Suite 10/11, Chandler, AZ, 85226, US

(73) Assignee: TOKYO ELECTRON LIMITED, Tokyo (JP)

(21) Appl. No.: 12/038,158

(22) Filed: Feb. 27, 2008

(51) Int. Cl. B44C 1/22; C23F 1/08

(52) U.S. Cl. 216/58; 156/345.24

(57) ABSTRACT

A processing system for treating a plurality of substrates is described. The processing system comprises a first batch processing system configured to chemically treat the plurality of substrates and a second batch processing system configured to thermally treat the plurality of substrates. A transfer system is coupled to the first batch processing system and the second batch processing system, and configured to transfer the plurality of substrates into and out of each batch processing system. Furthermore, a control system is coupled to the first batch processing system, the second batch processing system and the transfer system, and configured to execute a chemical removal process.

### CROSS-REFERENCE TO RELATED APPLICATIONS

This application is related to co-pending U.S. patent application Ser. No. 11/390,470, entitled “Batch Processing System and Method for Performing Chemical Oxide Removal”, Attorney docket no. 313530-P0026, filed on Mar. 28, 2006; co-pending U.S. patent application Ser. No. 10/705,200, entitled “Processing System and Method for Chemically Treating a Substrate”, Attorney docket no. 071469/0306773, filed on Nov. 12, 2003; co-pending U.S. patent application Ser. No. 10/704,969, entitled “Processing System and Method for Thermally Treating a Substrate”, Attorney docket no. 071469/0306775, filed on Nov. 12, 2003; and co-pending U.S. patent application Ser. No. 10/705,201, entitled “Processing System and Method for Treating a Substrate”, Attorney docket no. 071469/0306772, filed on Nov. 12, 2003. The entire contents of all of these applications are herein incorporated by reference in their entirety.

### BACKGROUND OF THE INVENTION

1. Field of Invention

The invention relates to a system and method for treating a plurality of substrates, and more particularly to a system and method for chemical and thermal treatment of a plurality of substrates.

2. Description of Related Art

In material processing methodologies, various processes are utilized to remove material from the surface of a substrate, including for instance etching processes, cleaning processes, etc. During pattern etching, fine features, such as trenches, vias, contact vias, etc., are formed in the surface layers of the substrate. For example, pattern etching comprises the application of a thin layer of radiation-sensitive material, such as photo-resist, to an upper surface of a substrate. A pattern is formed in the layer of radiation-sensitive material using a lithographic technique, and this pattern is transferred to the underlying layers using a dry etching process or series of dry etching processes.

Additionally, multi-layer masks, comprising a layer of radiation-sensitive material and one or more soft mask layers and/or hard mask layers, may be implemented for etching features in the thin film. For example, when etching features in the thin film using a hard mask, the mask pattern in the radiation-sensitive layer is transferred to the hard mask layer using a separate etch step preceding the main etch step for the thin film. The hard mask may, for example, be selected from several materials for silicon processing including silicon dioxide (SiO₂), silicon nitride (Si₃N₄), and carbon. Furthermore, in order to reduce the feature size formed in the thin film, the hard mask layer may be trimmed laterally. Thereafter, one or more of the mask layers and/or any residue accumulated on the substrate during subsequent processing may be removed using a dry cleaning process. One or more of the pattern forming, trimming, etching, or cleaning process steps may utilize a dry, non-plasma process for removing material from the substrate. For example, the dry, non-plasma process may comprise a chemical removal process that includes a two-step process involving a chemical treatment of the exposed surfaces of the substrate in order to alter the surface chemistry of these exposed surface layers, and a post treatment of the chemically altered exposed surfaces in order to desorb the altered surface chemistry. Although the chemical removal process exhibits very high selectivity for the removal of one material relative to another material, this process suffers from low throughput thus making the process less practical.

### SUMMARY OF THE INVENTION

The invention relates to a system and method for treating a plurality of substrates, and more particularly to a system and method for chemical and thermal treatment of a plurality of substrates.

Furthermore, the invention relates to a processing system for treating a plurality of substrates. The processing system comprises a first batch processing system configured to chemically treat the plurality of substrates and a second batch processing system configured to thermally treat the plurality of substrates. A transfer system is coupled to the first batch processing system and the second batch processing system, and configured to transfer the plurality of substrates into and out of each batch processing system. Furthermore, a control system is coupled to the first batch processing system, the second batch processing system and the transfer system, and configured to execute a chemical removal process.

According to one embodiment, a processing system for treating a plurality of substrates is described, comprising: a first batch processing system configured to chemically treat the plurality of substrates; a second batch processing system configured to thermally treat the plurality of substrates; a transfer system coupled to the first batch processing system and the second batch processing system, and configured to transfer the plurality of substrates into and out of the first batch processing system and transfer the plurality of substrates into and out of the second batch processing system; and a control system coupled to the first batch processing system, the second batch processing system and the transfer system, and configured to execute a chemical removal process, wherein the chemical removal process comprises chemically treating the plurality of substrates in the first batch processing system in order to chemically alter exposed surface layers on the plurality of substrates and thermally treating the plurality of substrates in the second batch processing system in order to elevate the temperature of the plurality of substrates and cause the evaporation of the chemically altered exposed surface layers.

According to another embodiment, a method for treating a plurality of substrates is described, comprising: loading a plurality of substrates into a first batch processing system using a transfer system; chemically treating the plurality of substrates by exposing the plurality of substrates to a gas composition comprising as incipient ingredients HF and optionally ammonia (NH₃); removing the plurality of substrates from the first batch processing system using the transfer system; after the removing, loading the plurality of substrates into a second batch processing system using the transfer system; and thermally treating the plurality of substrates by heating the plurality of substrates.

According to yet another embodiment, method for treating a plurality of substrates is described, comprising: loading a first plurality of substrates into a first batch processing system using a transfer system; concurrently loading a second plurality of substrates into a second batch processing system using the transfer system; chemically treating the first plurality of substrates by exposing the first plurality of substrates to a gas composition comprising as incipient ingredients HF and optionally ammonia (NH₃); and thermally treating the second plurality of substrates by heating the second plurality of substrates.

### BRIEF DESCRIPTION OF THE DRAWINGS

In the accompanying drawings:

FIG. 1 provides a schematic illustration of a processing system according to an embodiment;

FIG. 2A shows a top view of a processing system according to an embodiment;

FIG. 2B shows a cross-sectional view of the processing system depicted in FIG. 2A;

FIG. 3A shows a top view of a processing system according to an embodiment;

FIG. 3B shows a cross-sectional view of the processing system depicted in FIG. 3A;

FIG. 4A shows a top view of a processing system according to an embodiment;

FIG. 4B shows a cross-sectional view of the processing system depicted in FIG. 4A;

FIG. 5A shows a top view of a processing system according to an embodiment;

FIG. 5B shows a cross-sectional view of the processing system depicted in FIG. 5A;

FIG. 6 presents a simplified schematic of a batch processing system according to an embodiment;

FIG. 7 presents a simplified schematic of a batch processing system according to an embodiment;

FIG. 8 presents a simplified schematic of a batch processing system according to an embodiment;

FIG. 9 presents a simplified schematic of a batch processing system according to an embodiment;

FIG. 10 presents a simplified schematic of a batch processing system according to an embodiment;

FIG. 11 illustrates a method of processing a plurality of substrates according to another embodiment; and

FIG. 12 illustrates a method of processing a plurality of substrates according to yet another embodiment.

### DETAILED DESCRIPTION OF SEVERAL EMBODIMENTS

A processing system for treating a plurality of substrates is disclosed in various embodiments. However, one skilled in the relevant art will recognize that the various embodiments may be practiced without one or more of the specific details, or with other replacement and/or additional methods, materials, or components. In other instances, well-known structures, materials, or operations are not shown or described in detail to avoid obscuring aspects of various embodiments of the invention. Similarly, for purposes of explanation, specific numbers, materials, and configurations are set forth in order to provide a thorough understanding of the invention. Nevertheless, the invention may be practiced without specific details. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention. Furthermore, the particular features, structures, materials, or characteristics may be combined in any suitable manner in one or more embodiments. Various additional layers and/or structures may be included and/or described features may be omitted in other embodiments.

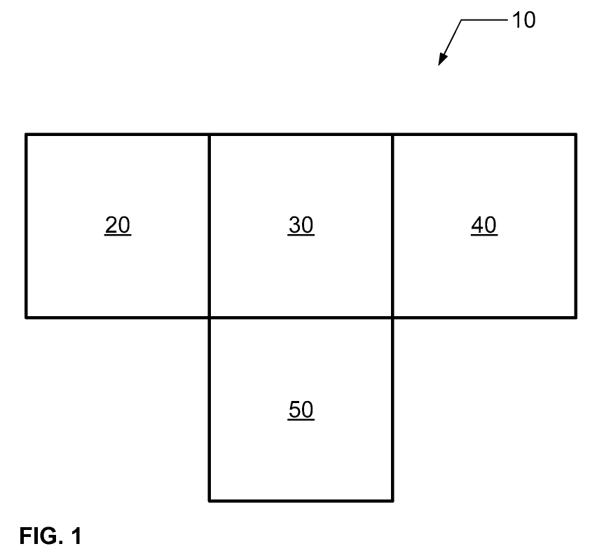

According to an embodiment, FIG. 1 presents processing system 10 for treating a plurality of substrates. The processing system 10 comprises a first batch processing system 20 configured to chemically treat the plurality of substrates and a second batch processing system 40 configured to thermally treat the plurality of substrates. A transfer system 30 is coupled to the first batch processing system 20 and the second batch processing system 40, and configured to transfer the plurality of substrates into and out of each batch processing system. Furthermore, a control system 50 is coupled to the first batch processing system 20, the second batch processing system 40 and the transfer system 30, and configured to execute a chemical removal process.

The chemical removal process may include a dry, non-plasma, chemical removal process, such as a chemical oxide removal process, to, for example, trim an oxide mask or remove native oxide or remove a SiOₓ-containing residue or other residue. For example, as described above, the first batch processing system 20 is configured to chemically treat the plurality of substrates, and second batch processing system 40 configured to thermally treat the plurality of substrates. By performing the chemical treatment in the first batch processing system 20 and the thermal treatment in the second batch processing system 40, cross-contamination between systems may be reduced.

During chemical treatment, the first batch processing system 20 is configured to introduce a process gas comprising a first gaseous component having as an incipient ingredient HF and an optional second gaseous component having as an incipient ingredient ammonia (NH₃). The two gaseous components may be introduced together, or independently of one another. Additionally, either gaseous component, or both, can be introduced with a carrier gas, such as an inert gas. The inert gas can comprise a noble gas, such as argon. The chemical treatment of the exposed film or residue on the plurality of substrates is performed by exposing this film or residue to the two gaseous components which, in turn, causes a chemical alteration of the film surface or residue. For a thin film, the chemical alteration proceeds to a self-limiting depth.

During thermal treatment, the second batch processing system 40 is configured to elevate the temperature of the plurality of substrates to a temperature ranging from approximately 50 degrees C to approximately 450 degrees C, and desirably, the substrate temperature may range from approximately 100 degrees C to approximately 300 degrees C. For example, the substrate temperature may range from approximately 100 degrees C to approximately 200 degrees C. The thermal treatment of the chemically altered surface layers or residue causes the evaporation of these surface layers or residue.

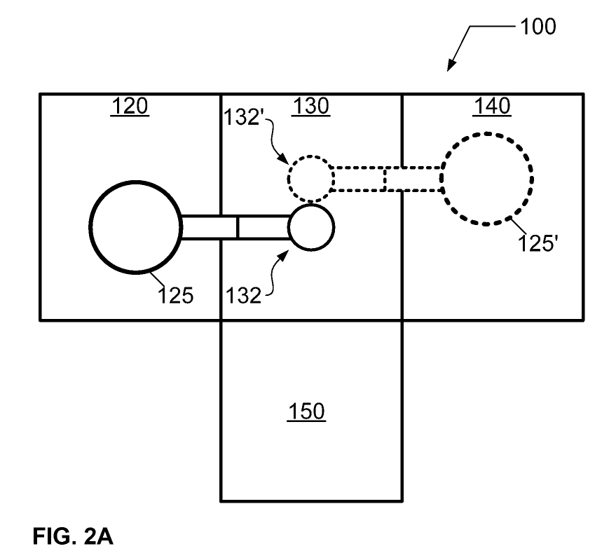

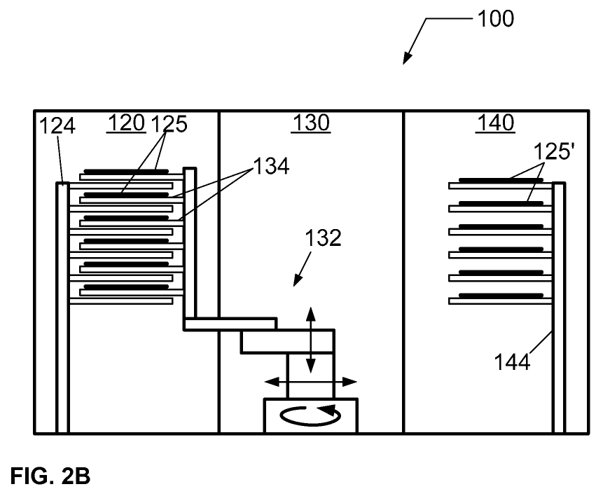

Referring now to FIGS. 2A and 2B, a processing system 100 for treating a plurality of substrates is presented. The processing system 100 comprises a first batch processing system 120 configured to chemically treat the plurality of substrates and a second batch processing system 140 configured to thermally treat the plurality of substrates. A transfer system 130 is coupled to the first batch processing system 120 and the second batch processing system 140, and configured to transfer the plurality of substrates into and out of each batch processing system. Furthermore, a control system 150 is coupled to the first batch processing system 120, the second batch processing system 140 and the transfer system 130, and configured to execute a chemical removal process.

As shown in FIG. 2B, a first substrate holder 124 is positioned within the first batch processing system 120 and configured to support the plurality of substrates 125, wherein the plurality of substrates 125 are aligned vertically and each of the plurality of substrates lies in a unique horizontal plane that is spaced vertically at an interval from an adjacent horizontal plane. Additionally, a second substrate holder 144 is positioned within the second batch processing system 140 and configured to support the plurality of substrates 125′, wherein the plurality of substrates 125′ are aligned vertically and each of the plurality of substrates lies in a unique horizontal plane that is spaced vertically at an interval from an adjacent horizontal plane.

A multi-substrate transfer device 132 is located in the transfer system 130, and configured to receive the plurality of substrates 125 (or 125′) and perform one or more of loading the plurality of substrates 125 onto the first substrate holder 124 in the first batch processing system 120 or loading the plurality of substrates 125′ onto the second substrate holder 144 in the second batch processing system 140. The multi-substrate transfer device 132 comprises a substrate loading arm having a plurality of substrate blades 134, each of the plurality of substrate blades 134 is configured to receive one of the plurality of substrates 125 (or 125′) and load one of the plurality of substrates onto the first substrate holder 124 or the second substrate holder 144. As illustrated in FIG. 2B, the multi-substrate transfer device 132 may be configured for multiple translational and rotational degrees of freedom. For example, the multi-substrate transfer device 132 may be capable of vertical motion, horizontal motion in two orthogonal directions, and rotational motion about a vertical axis of revolution. Further yet, as illustrated in FIG. 2A, a second multi-substrate transfer device 132′ may be positioned in transfer system 130 to further increase throughput.

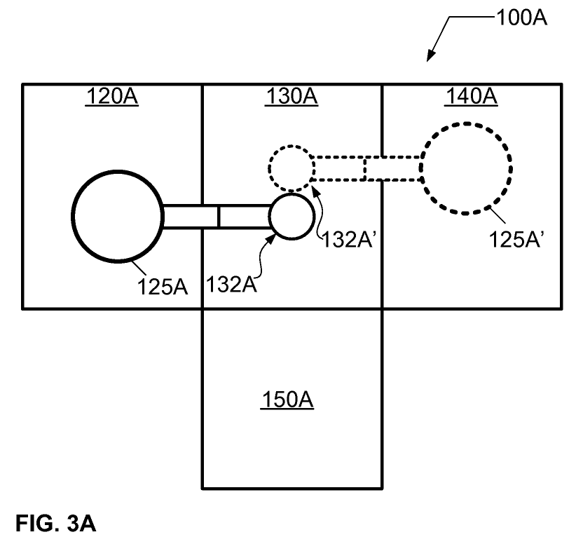

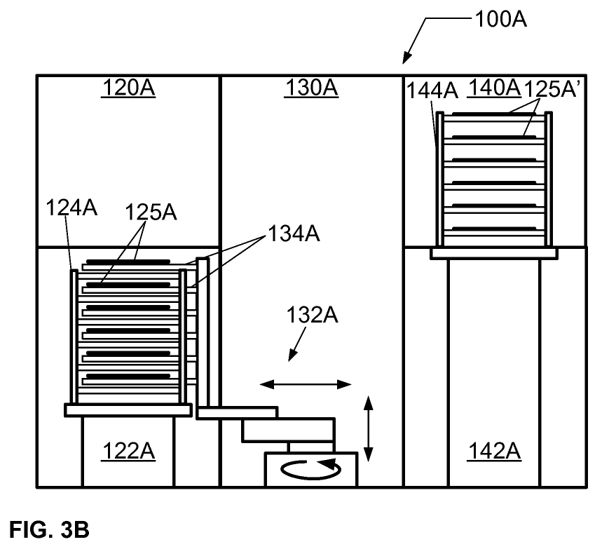

Referring now to FIGS. 3A and 3B, a processing system 100A for treating a plurality of substrates is presented. The processing system 100A comprises a first batch processing system 120A configured to chemically treat the plurality of substrates and a second batch processing system 140A configured to thermally treat the plurality of substrates. A transfer system 130A is coupled to the first batch processing system 120A and the second batch processing system 140A, and configured to transfer the plurality of substrates into and out of each batch processing system. Furthermore, a control system 150A is coupled to the first batch processing system 120A, the second batch processing system 140A and the transfer system 130A, and configured to execute a chemical removal process.

As shown in FIG. 3B, a first substrate holder 124A is positioned on a first elevator 122A beneath the first batch processing system 120A and configured to support the plurality of substrates 125A, wherein the plurality of substrates 125A are aligned vertically and each of the plurality of substrates lies in a unique horizontal plane that is spaced vertically at an interval from an adjacent horizontal plane. Additionally, a second substrate holder 144A is positioned on a second elevator 142A beneath the second batch processing system 140A and configured to support the plurality of substrates 125A′, wherein the plurality of substrates 125A′ are aligned vertically and each of the plurality of substrates lies in a unique horizontal plane that is spaced vertically at an interval from an adjacent horizontal plane. The first elevator 122A is configured to elevate and seal the first substrate holder 124A with the first batch processing system 120A. The second elevator 142A is configured to elevate and seal the second substrate holder 144A with the second batch processing system 140A.

A multi-substrate transfer device 132A is located in the transfer system 130A, and configured to receive the plurality of substrates 125A (or 125A′) and perform one or more of loading the plurality of substrates 125A onto the first substrate holder 124A on the first elevator 122A or loading the plurality of substrates 125A′ onto the second substrate holder 144A on the second elevator 142A. The multi-substrate transfer device 132A comprises a substrate loading arm having a plurality of substrate blades 134A, each of the plurality of substrate blades 134A is configured to receive one of the plurality of substrates 125A (or 125A′) and load one of the plurality of substrates onto the first substrate holder 124A or the second substrate holder 144A. As illustrated in FIG. 3B, the multi-substrate transfer device 132A may be configured for multiple translational and rotational degrees of freedom. For example, the multi-substrate transfer device 132A may be capable of vertical motion, horizontal motion in two orthogonal directions, and rotational motion about a vertical axis of revolution. Further yet, as illustrated in FIG. 3A, a second multi-substrate transfer device 132A′ may be positioned in transfer system 130A to further increase throughput.

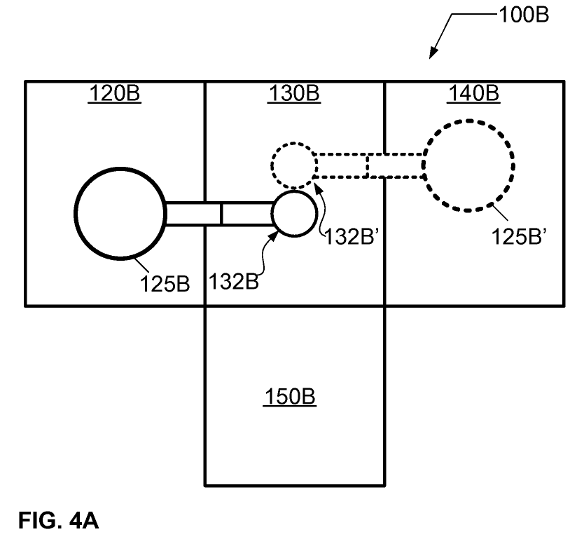

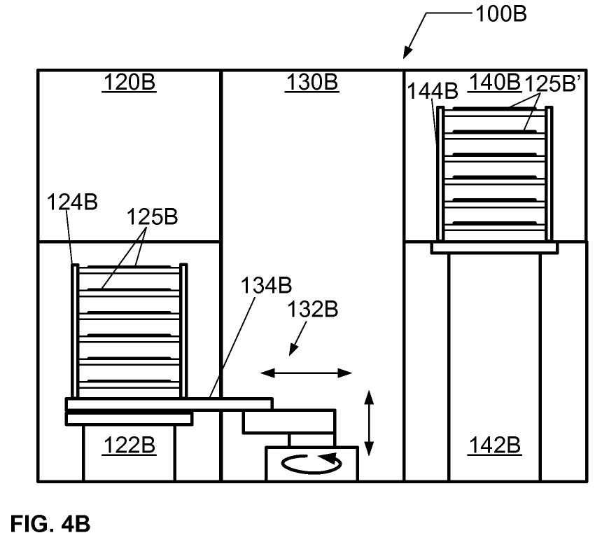

Referring now to FIGS. 4A and 4B, a processing system 100B for treating a plurality of substrates is presented. The processing system 100B comprises a first batch processing system 120B configured to chemically treat the plurality of substrates and a second batch processing system 140B configured to thermally treat the plurality of substrates. A transfer system 130B is coupled to the first batch processing system 120B and the second batch processing system 140B, and configured to transfer the plurality of substrates into and out of each batch processing system. Furthermore, a control system 150B is coupled to the first batch processing system 120B, the second batch processing system 140B and the transfer system 130B, and configured to execute a chemical removal process.

As shown in FIG. 4B, a first substrate holder 124B is positioned on a first elevator 122B beneath the first batch processing system 120B and configured to support the plurality of substrates 125B, wherein the plurality of substrates 125B are aligned vertically and each of the plurality of substrates lies in a unique horizontal plane that is spaced vertically at an interval from an adjacent horizontal plane. Additionally, a second substrate holder 144B is positioned on a second elevator 142B beneath the second batch processing system 140B and configured to support the plurality of substrates 125B′, wherein the plurality of substrates 125B′ are aligned vertically and each of the plurality of substrates lies in a unique horizontal plane that is spaced vertically at an interval from an adjacent horizontal plane. The first elevator 122B is configured to elevate and seal the first substrate holder 124B with the first batch processing system 120B. The second elevator 142B is configured to elevate and seal the second substrate holder 144B with the second batch processing system 140B.

The transfer system 130B is configured to load the first substrate holder 124B with the plurality of substrates 125B. Additionally, the transfer system 130B is configured to load the second substrate holder 144B with the plurality of substrates 125B′. A substrate holder transfer device 132B is located in the transfer system 130B, and configured to receive the first substrate holder 124B and position the first substrate holder 124B on the first elevator 122B. Furthermore, the substrate holder transfer device 132B is configured to receive the second substrate holder 144B and position the second substrate holder 144B on the second elevator 142B. The substrate holder transfer device 132B comprises a substrate loading arm 134B configured to support and transfer the first substrate holder 124B or the second substrate holder 144B. As illustrated in FIG. 4B, the substrate holder transfer device 132B may be configured for multiple translational and rotational degrees of freedom. For example, the substrate holder transfer device 132B may be capable of vertical motion, horizontal motion in two orthogonal directions, and rotational motion about a vertical axis of revolution. Further yet, as illustrated in FIG. 4A, a second substrate holder transfer device 132B′ may be positioned in transfer system 130B to further increase throughput.

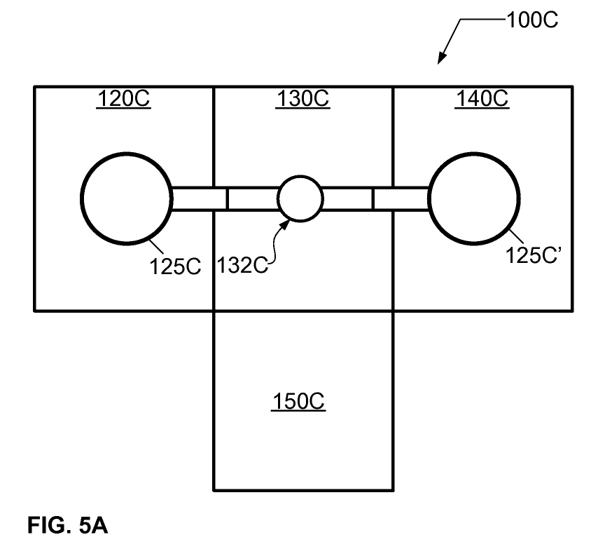

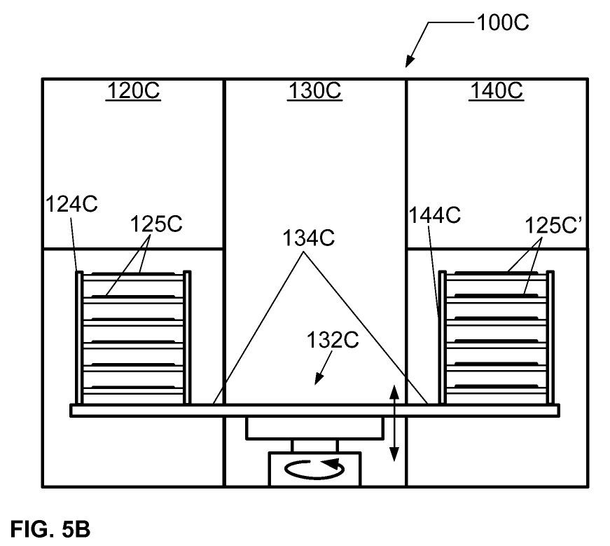

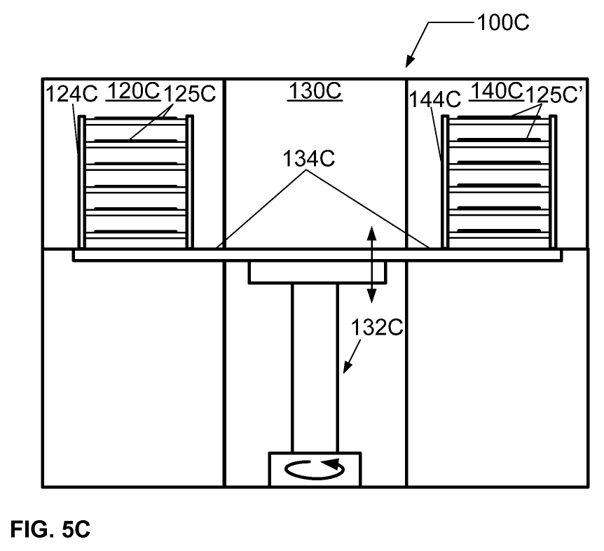

Referring now to FIGS. 5A, 5B and 5C, a processing system 100C for treating a plurality of substrates is presented. The processing system 100C comprises a first batch processing system 120C configured to chemically treat the plurality of substrates and a second batch processing system 140C configured to thermally treat the plurality of substrates. A transfer system 130C is coupled to the first batch processing system 120C and the second batch processing system 140C, and configured to transfer the plurality of substrates into and out of each batch processing system. Furthermore, a control system 150C is coupled to the first batch processing system 120C, the second batch processing system 140C and the transfer system 130C, and configured to execute a chemical removal process.

As shown in FIG. 5B, a first substrate holder 124C having a first plurality of substrates 125C and a second substrate holder 144C having a second plurality of substrates 125C′ are positioned on a multi-holder transfer device 132C. The multi-holder transfer device 132C comprises a multi-arm substrate loading device 134C configured to support and transfer the first plurality of substrates 125C and the second plurality of substrates 125C′. The first plurality of substrates 125C are aligned vertically and each of the plurality of substrates lies in a unique horizontal plane that is spaced vertically at an interval from an adjacent horizontal plane. Additionally, the second plurality of substrates 125C′ are aligned vertically and each of the plurality of substrates lies in a unique horizontal plane that is spaced vertically at an interval from an adjacent horizontal plane. The multi-holder transfer device 132C is configured to align the first substrate holder 124C with the first batch processing system 120C and align the second substrate holder 144C with the second batch processing system 140C, and concurrently elevate and seal the first substrate holder 124C with the first batch processing system 120C and the second substrate holder 144C with the second batch processing system 140C.

The transfer system 130C is configured to load the first substrate holder 124C with the plurality of substrates 125C. Additionally, the transfer system 130C is configured to load the second substrate holder 144C with the plurality of substrates 125C′. As shown in FIG. 5B, the multi-holder transfer device 132C is positioned to receive the first plurality of substrates 125C and the second plurality of substrates 125C′. Then, as shown in FIG. 5C, the multi-holder transfer device 132C has elevated the first substrate holder 124C and the second substrate holder 144C, and sealed each substrate holder in a respective batch processing system. The multi-holder transfer device 132C is further configured to concurrently retract and unseal the first substrate holder 124C with the first batch processing system 120C and the second substrate holder 144C with the second batch processing system 140C, rotate to align the first substrate holder 124C with the second batch processing system 140C and align the second substrate holder 144C with the first batch processing system 120C, and concurrently elevate and seal the first substrate holder 124C with the second batch processing system 140C and the second substrate holder 144C with the first batch processing system 120C.

Referring to FIGS. 1, 2A, 2B, 3A, 3C, 4A, 4B, 5A, 5B and 5C, the first batch processing system 20 (120, 120A, 120B, 120C) and the second batch processing system 40 (140, 140A, 140B, 140C) may, for example, comprise a processing element within a multi-element manufacturing system (not shown). The transfer system 30 (130, 130A, 130B, 130C) may comprise a dedicated substrate handler for moving one or more substrates between the first and second batch processing systems and the multi-element manufacturing system. Additionally, the multi-element manufacturing system may permit the transfer of substrates to and from batch processing systems, such as the first and second batch processing system described herein, and single-substrate processing systems. Further, the multi-element manufacturing system may permit the transfer of substrates to and from processing elements including such devices as etch systems, deposition systems, coating systems, patterning systems, metrology systems, etc. The multi-element manufacturing system may, for example, include cluster-tool platforms.

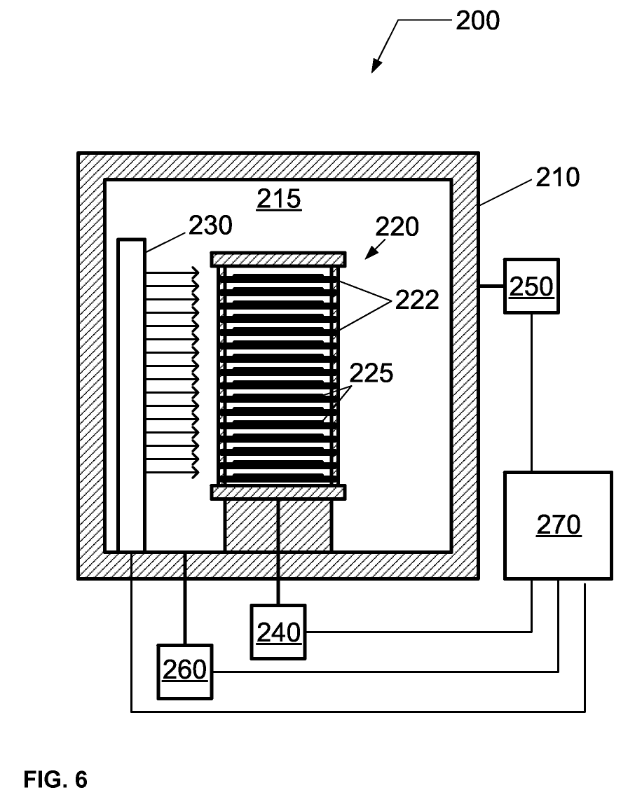

According to an embodiment, a first batch processing system 200 configured to perform a chemical treatment process on a plurality of substrates 225 is depicted in FIG. 6. The first batch processing system 200 comprises a process chamber 210, a substrate holder 220 configured to support the plurality of substrates 225 within a process space 215, a process gas injection system 230 configured to introduce a process gas to the process space 215, a substrate temperature control system 240 configured to adjust the temperature of the plurality of substrate 225, a chamber temperature control system configured to adjust the temperature of the process chamber 210, and a pressure control system configured to adjust the pressure in the process chamber 210. Furthermore, the first batch processing system comprises a control system 270 coupled to the process gas injection system 230, the substrate temperature control system 240, the chamber temperature control system 250, and the pressure control system 260.

The process gas injection system 230 is configured to introduce a process gas comprising as incipient ingredients HF and optionally ammonia (NH₃) to the first batch processing system 200. The two gaseous components may be introduced together, or independently of one another. Additionally, either gaseous component, or both, can be introduced with a carrier gas, such as an inert gas. The inert gas can comprise a noble gas, such as argon. The chemical treatment of the exposed film or residue on the plurality of substrates is performed by exposing this film or residue to the two gaseous components which, in turn, causes a chemical alteration of the film surface or residue. For a thin film, the chemical alteration proceeds to a self-limiting depth.

The substrate temperature control system 240 comprises one or more temperature control elements 222 configured to adjust the temperature of the plurality of substrates 225. The one or more temperature control elements 222 are configured to adjust the temperature of the plurality of substrates 225 to a value ranging from about 20 degrees C to about 100 degrees C. Alternatively, the one or more temperature control elements 222 are configured to adjust the temperature of the plurality of substrates 225 to a value ranging from about 25 degrees C to about 60 degrees C.

The one or more temperature control elements 222 may comprise a heating element, a cooling element, or combination thereof. For example, the one or more temperature control elements 222 may comprise a resistive heating element, such as a film heater, cartridge heater, ceramic heater, etc. Additionally, for example, the one or more temperature control elements 222 may comprise a thermoelectric device. The thermoelectric device may comprise a Peltier module. Furthermore, for example, the one or more temperature control elements 222 may comprise a radiant heating device.

Peltier modules are small solid-state devices that function as heat pumps. They are based on the fact that application of voltage to two joint materials in some cases produces heat release or heat absorption, depending on the polarity, near the contact region. For instance, this module includes p-type and n-type semiconductor materials connected by conductors and enclosed between ceramic layers. In operation, when electric power is applied to the Peltier module, one side of the device becomes colder while the other side becomes hotter. Changing voltage polarity reverses the effect, and the side with the heat absorption becomes the heat releasing side, and vice versa. With these solid state devices, the heating power and the cooling power are approximately in direct proportion to the electric power or to the applied voltage.

The chamber temperature control system 250 comprises one or more temperature control elements (not shown) configured to adjust the temperature of the process chamber 210. The one or more temperature control elements are configured to adjust the temperature of the process chamber 210 to a value ranging from about 20 degrees C to about 200 degrees C. The one or more temperature control elements may comprise a heating element, a cooling element, or combination thereof. For example, the one or more temperature control elements may comprise a resistive heating element, or a recirculating heating/cooling fluid flow channel.

The pressure control system 260 can include one or more pressure valves (not shown) for exhausting the process chamber 210 and/or for regulating the pressure within the process chamber 210. Alternately, the pressure control system 260 can also include one or more pumps (not shown). For example, a pumping system may be used to evacuate the process chamber 210.

Control system 270 includes a microprocessor, memory, and a digital I/O port (potentially including D/A and/or A/D converters) capable of generating control voltages sufficient to communicate and activate inputs to the process chamber 210, the substrate holder 220, the process gas injection system 230, the substrate temperature control system 240, the chamber temperature control system 250, and the pressure control system 260 as well as monitor outputs from these systems. A program stored in the memory is utilized to interact with processing system 200 according to a stored process recipe.

Alternately, or in addition, control system 270 can be coupled to a one or more additional controllers/computers (not shown), and control system 270 can obtain setup and/or configuration information from an additional controller/computer.

The control system 270 can be used to configure any number of processing elements, and the control system 270 can collect, provide, process, store, and display data from processing elements. The control system 270 can comprise a number of applications for controlling one or more of the processing elements. For example, control system 270 can include a graphic user interface (GUI) component (not shown) that can provide easy to use interfaces that enable a user to monitor and/or control one or more processing elements.

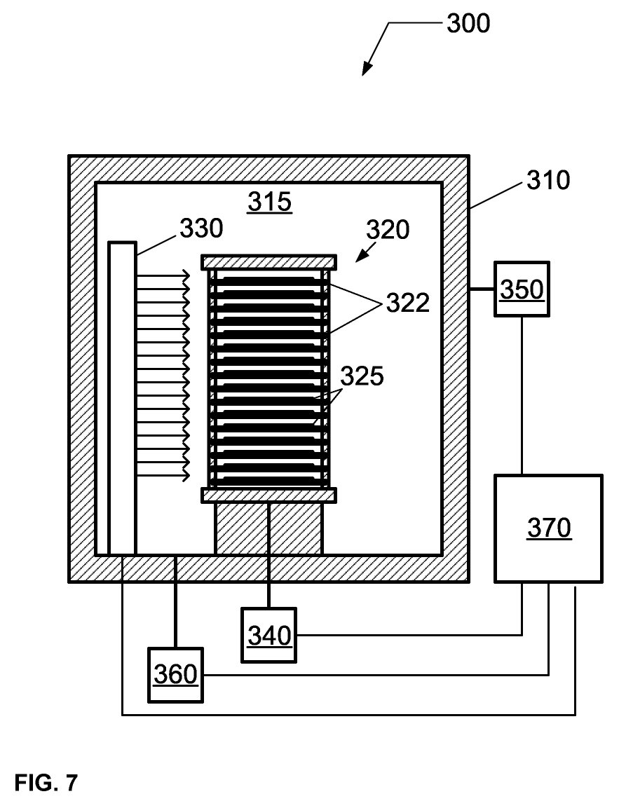

According to an embodiment, a second batch processing system 300 configured to perform a thermal treatment process on a plurality of substrates 325 is depicted in FIG. 7. The second batch processing system 300 comprises a process chamber 310, a substrate holder 320 configured to support the plurality of substrates 325 within a process space 315, a process gas injection system 330 configured to introduce a process gas to the process space 315, a substrate temperature control system 340 configured to adjust the temperature of the plurality of substrate 325, a chamber temperature control system 350 configured to adjust the temperature of the process chamber 310, and a pressure control system configured to adjust the pressure in the process chamber 310. Furthermore, the first batch processing system comprises a control system 370 coupled to the process gas injection system 330, the substrate temperature control system 340, the chamber temperature control system 350, and the pressure control system 360.

The process gas injection system 330 is configured to introduce a process gas comprising an inert gas to the second batch processing system 300. The inert gas can comprise nitrogen (N₂) or a noble gas, such as argon. The thermal treatment of the chemically altered surface layers or residue causes the evaporation of these surface layers or residue.

The substrate temperature control system 340 comprises one or more temperature control elements 322 configured to adjust the temperature of the plurality of substrates 325. The one or more temperature control elements 322 are configured to adjust the temperature of the plurality of substrates 325 to a value greater than or equal to about 50 degrees C. Alternatively, the one or more temperature control elements 322 are configured to adjust the temperature of the plurality of substrates 325 to a value greater than or equal to about 100 degrees C. Alternatively, the one or more temperature control elements 322 are configured to adjust the temperature of the plurality of substrates 325 to a value ranging from about 50 degrees C to about 450 degrees C. Alternatively, the one or more temperature control elements 322 are configured to adjust the temperature of the plurality of substrates 325 to a value ranging from about 100 degrees C to about 300 degrees C. Alternatively yet, the one or more temperature control elements 322 are configured to adjust the temperature of the plurality of substrates 325 to a value ranging from about 100 degrees C to about 200 degrees C.

The one or more temperature control elements 322 may comprise a heating element, a cooling element, or combination thereof. For example, the one or more temperature control elements 322 may comprise a resistive heating element, such as a film heater, cartridge heater, ceramic heater, etc. Additionally, for example, the one or more temperature control elements 322 may comprise a thermoelectric device. The thermoelectric device may comprise a Peltier module. Furthermore, for example, the one or more temperature control elements 322 may comprise a radiant heating device.

The chamber temperature control system 350 comprises one or more temperature control elements (not shown) configured to adjust the temperature of the process chamber 310. The one or more temperature control elements are configured to adjust the temperature of the process chamber 310 to a value ranging from about 20 degrees C to about 200 degrees C. The one or more temperature control elements may comprise a heating element, a cooling element, or combination thereof. For example, the one or more temperature control elements may comprise a resistive heating element, or a recirculating heating/cooling fluid flow channel.

The pressure control system 360 can include one or more pressure valves (not shown) for exhausting the process chamber 310 and/or for regulating the pressure within the process chamber 310. Alternately, the pressure control system 360 can also include one or more pumps (not shown). For example, a pumping system may be used to evacuate the process chamber 310.

Control system 370 includes a microprocessor, memory, and a digital I/O port (potentially including D/A and/or A/D converters) capable of generating control voltages sufficient to communicate and activate inputs to the process chamber 310, the substrate holder 320, the process gas injection system 330, the substrate temperature control system 340, the chamber temperature control system 350, and the pressure control system 360 as well as monitor outputs from these systems. A program stored in the memory is utilized to interact with processing system 300 according to a stored process recipe.

Alternately, or in addition, control system 370 can be coupled to a one or more additional controllers/computers (not shown), and control system 370 can obtain setup and/or configuration information from an additional controller/computer.

The control system 350 can be used to configure any number of processing elements, and the control system 370 can collect, provide, process, store, and display data from processing elements. The control system 370 can comprise a number of applications for controlling one or more of the processing elements. For example, control system 370 can include a graphic user interface (GUI) component (not shown) that can provide easy to use interfaces that enable a user to monitor and/or control one or more processing elements.

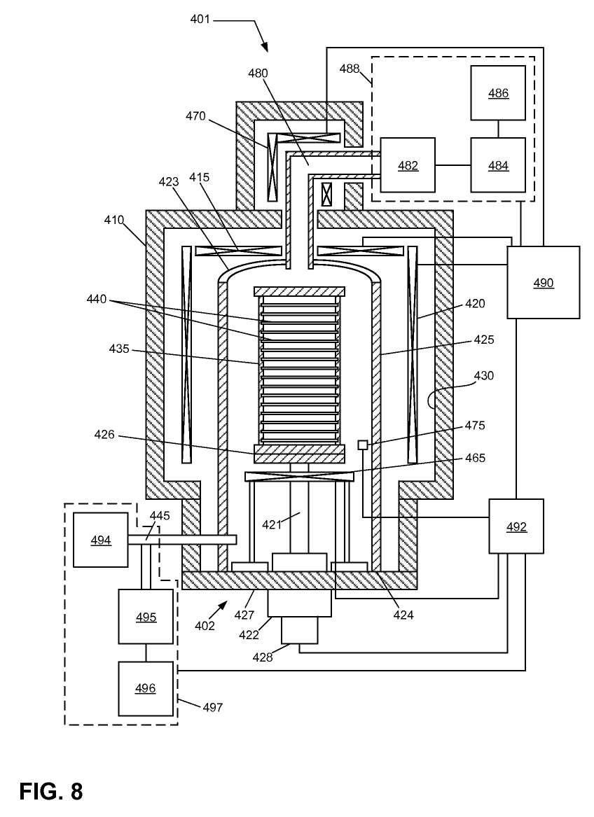

Referring now to FIG. 8, a simplified block diagram of a batch processing system 401 is shown according to another embodiment. The batch processing system 401 may be configured to perform a chemical treatment process or a thermal treatment process. The batch processing system 401 contains a process chamber 410 and a process tube 425 that has an upper end 423 connected to an exhaust system 488 via an exhaust duct 480, and a lower end 424 hermetically joined to a lid 427 of cylindrical manifold 402. The exhaust duct 480 discharges gases from the process tube 425 to exhaust system 488 to maintain a pre-determined pressure, e.g., atmospheric or below atmospheric pressure, in the processing system 401.

A substrate holder 435 for holding a plurality of substrates (wafers) 440 in a tier-like manner (in respective horizontal planes at vertical intervals) is placed in the process tube 425. The substrate holder 435 resides on a turntable 426 that is mounted on a rotating shaft 421 penetrating the lid 427 and driven by a drive system 428 (which may comprise an electric motor). The turntable 426 can be rotated during processing to improve overall film uniformity or, alternately, the turntable can be stationary during processing. The lid 427 is mounted on an elevator 422 for transferring the substrate holder 435 in and out of the process tube 425. When the lid 427 is positioned at its uppermost position, the lid 427 is adapted to close the open end of the manifold 402.

When performing chemical treatment of the plurality of substrates, a process gas injection system 497 is configured for introducing a process gas comprising a first gaseous component including as an incipient ingredient HF and an optional second gaseous component including as an incipient ingredient ammonia (NH₃) to process chamber 410, with or without an additional carrier gas. A plurality of gas supply lines can be arranged around the manifold 402 to supply a plurality of gases into the process tube 425 through the gas supply lines. The two gaseous components may be introduced together, or independently of one another. When performing thermal treatment of the plurality of substrates, the process gas injection system 497 is configured for introducing a process gas comprising an inert gas, such as nitrogen or a noble gas.

In FIG. 8, only one gas supply line 445 among the plurality of gas supply lines is shown. The gas supply line 445 (as shown) is connected to a process gas source 494. In general, the process gas source 494 can supply process gases for processing the substrates 440, including, gases for a dry, non-plasma, chemical removal process, such as chemical oxide removal. For example, a chemical oxide removal process includes a dry chemical process whereby an oxide film is exposed to a process gas comprising as incipient ingredients HF and ammonia, concurrently with or followed by thermal treatment to evaporate the chemically altered surface layer on the oxide film. Additionally, process gas injection system 497 may further comprise an additional process gas source 496 and a remote plasma source 495 configured to produce radicals or fragmented molecules of the process gas from process gas source 496. The introduction of gaseous radicals to process chamber 410 can facilitate other processes, such as etching processes and ashing or stripping process, that may be used in conjunction with the dry, non-plasma process described herein.

A cylindrical heat reflector 430 is disposed so as to surround the reaction tube 425. For example, the cylindrical heat reflector 430 may be disposed within the inner surface of process chamber 410. The heat reflector 430 has a mirror-finished inner surface to suppress dissipation of radiation heat radiated by the thermal treatment system including a main heater 420, a bottom heater 465, a top heater 415, and an exhaust duct heater 470. A helical cooling water passage (not shown) may be formed in the wall of the process chamber 410 as a cooling medium passage.

The exhaust system 488 comprises a vacuum pump 486, a trap 484, and automatic pressure controller (APC) 482. The vacuum pump 486 can, for example, include a dry vacuum pump capable of a pumping speed up to 20,000 liters per second (and greater). During processing, gases can be introduced into the process chamber 410 via the gas supply line 445 of the fluid distribution system 497 and the process pressure can be adjusted by the APC 482. The trap 484 can collect by-products from the process chamber 410.

The process monitoring system 492 comprises a sensor 475 capable of real-time process monitoring and can, for example, include a mass spectrometer (MS), a Fourier transform infra-red (FTIR) spectrometer, or a particle counter. A controller 490 includes a microprocessor, a memory, and a digital I/O port capable of generating control voltages sufficient to communicate and activate inputs to the batch processing system 401 as well as monitor outputs from the batch processing system 401. Moreover, the controller 490 is coupled to and can exchange information with process gas injection system 497, drive system 428, process monitoring system 492, main heater 420, bottom heater 465, top heater 415, exhaust duct heater 470, and exhaust system 488.

The controller 490 may also be implemented as a general purpose computer, processor, digital signal processor, etc., which causes a substrate processing apparatus to perform a portion or all of the processing steps of the invention in response to the controller 490 executing one or more sequences of one or more instructions contained in a computer readable medium. The computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

The controller 490 may be locally located relative to the batch processing system 401, or it may be remotely located relative to the batch processing system 401 via an internet or intranet. Thus, the controller 490 can exchange data with the batch processing system 401 using at least one of a direct connection, an intranet, and the internet. The controller 490 may be coupled to an intranet at a customer site (i.e., a device maker, etc.), or coupled to an intranet at a vendor site (i.e., an equipment manufacturer). Furthermore, another computer (i.e., controller, server, etc.) can access controller 490 to exchange data via at least one of a direct connection, an intranet, and the internet.

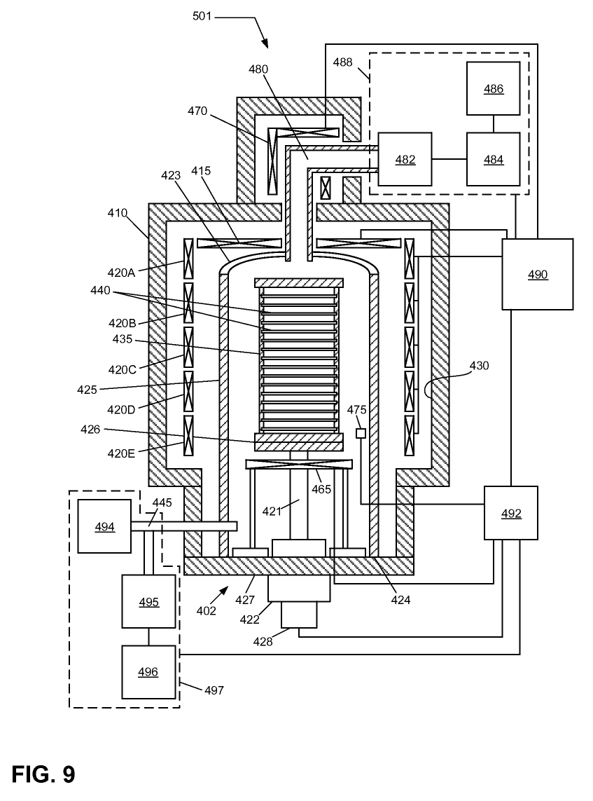

Referring now to FIG. 9, a simplified block diagram of a batch processing system 501 is shown according to another embodiment. The batch processing system 501 contains many of the same features as batch processing system 401 illustrated in FIG. 8 and described above. However, batch processing system 501 further comprises a thermal treatment system having a multiple zone main heater having heating elements 420A, 420B, 420C, 420D and 420E. Although, five (5) heating elements are illustrated, the number of heating elements may vary, e.g., the number may be more or less. Each heating element may comprise a carbon resistive heating element, or other conventional resistive heating element. Additionally, the configuration, or geometry, or both the configuration and geometry of the heating elements may vary from that illustrated in FIG. 9. The multiple zone main heater can facilitate additional control of spatial variations in substrate temperature throughout the batch of substrates. For example, the multiple zone main heater can achieve a heating ramp rate of up to approximately 40 degrees C per minute, with a temperature controllability of plus or minus 1 degree C.

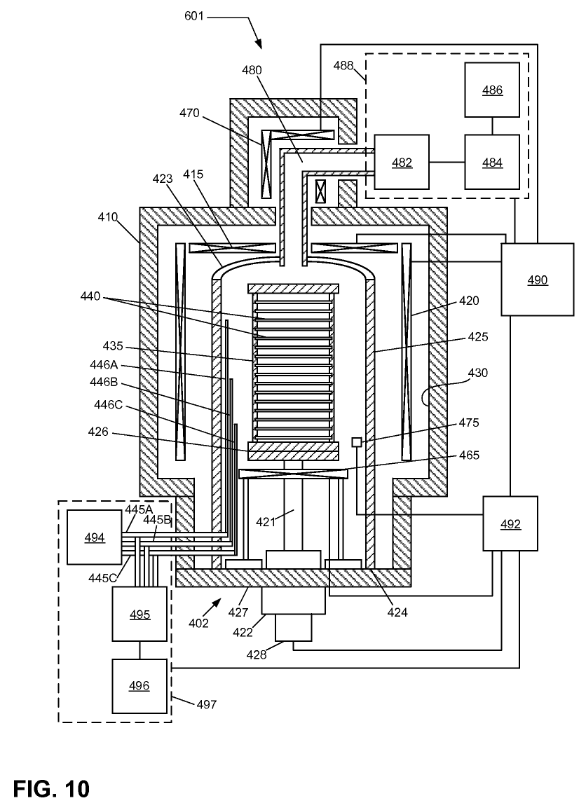

Referring now to FIG. 10, a simplified block diagram of a batch processing system 601 is shown according to another embodiment. The batch processing system 601 contains many of the same features as batch processing system 401 illustrated in FIG. 8 and described above. However, batch processing system 601 further comprises a multiple zone gas injection system comprising a plurality of gas supply lines 445A, 445B and 445C providing a flow of process gas to a plurality of zones along substrate holder 435 via a plurality of gas injection devices 446A, 446B and 446C. Each gas injection device 446A-C may include one or more gas injection orifices of varying size or distribution, or both, along each gas injection device. Any flow property, including the concentration of process gas, flow rate of process gas, etc., may be varied or controlled to each region of the process chamber 410.

It is to be understood that the batch-type processing systems 200, 300, 401, 501, and 601 depicted in FIGS. 6, 7, 8, 9, and 10 are shown for exemplary purposes only, as many variations of the specific hardware can be used to practice the present invention, and these variations will be readily apparent to one having ordinary skill in the art. The batch processing systems 200, 300, 401, 501 and 601 in FIGS. 6, 7, 8, 9 and 10 can, for example, process substrates of any size, such as 200 mm substrates, 300 mm substrates, or even larger substrates. Furthermore, the batch processing systems 200, 300, 401, 501 and 601 can simultaneously process up to about 200 substrates, or more. Alternately, the processing system can simultaneously process up to about 25 substrates. In addition to semiconductor substrates, e.g., silicon wafers, the substrates can, for example, comprise LCD substrates, glass substrates, or compound semiconductor substrates. Components from any of processing system 200, 300, 401, 501 or 601 may be employed in any of the other processing systems.

An exemplary vapor transport-supply apparatus is described in U.S. Pat. No. 5,035,200, assigned to Tokyo Electron Limited, which is incorporated herein by reference in its entirety. Additionally, an exemplary vapor transport-supply apparatus may include a TELFormula® batch processing system, commercially available from Tokyo Electron Limited.

In one example, part of or all of an oxide film, such as a native oxide film, is removed on a plurality of substrates using a chemical oxide removal process. In another example, part of or all of an oxide film, such as an oxide hard mask, is trimmed on a plurality of substrates using a chemical oxide removal process. The oxide film can comprise silicon dioxide (SiO₂), or more generally, SiOₓ, for example. In yet another example, part or all of a SiOₓ-containing residue is removed on a plurality of substrates.

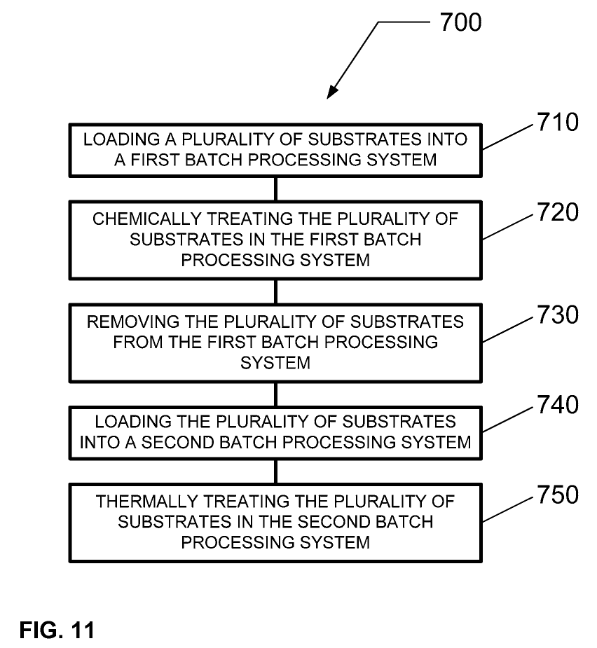

Referring now to FIG. 11, a method for treating a plurality of substrates is described according to another embodiment. The method comprises a flow chart 700 beginning in 710 with loading a plurality of substrates into a first batch processing system using a transfer system.

In 720, the plurality of substrates is chemically treated by exposing the plurality of substrates to a gas composition comprising as incipient ingredients HF and optionally ammonia (NH₃).

In 730, the plurality of substrates is removed from the first batch processing system using the transfer system.

In 740, after the removing, the plurality of substrates is loaded into a second batch processing system using the transfer system.

In 750, the plurality of substrates is thermally treated by heating the plurality of substrates. By performing the chemical treatment in the first batch processing system and the thermal treatment in the second batch processing system, cross-contamination between systems may be reduced.

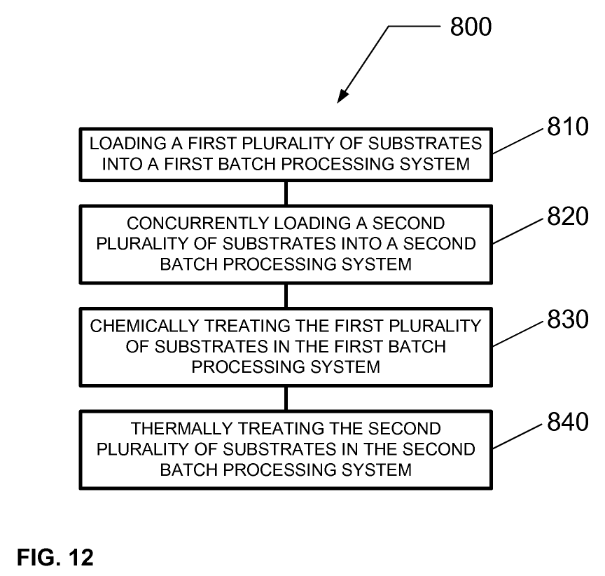

Referring now to FIG. 12, a method for treating a plurality of substrates is described according to another embodiment. The method comprises a flow chart 800 beginning in 810 with loading a plurality of substrates into a first batch processing system using a transfer system.

In 820, a second plurality of substrates is concurrently loaded into a second batch processing system using the transfer system.

In 830, the first plurality of substrates is chemically treated in the first batch processing system by exposing the first plurality of substrates to a gas composition comprising as incipient ingredients HF and optionally ammonia (NH₃).

In 840, the second plurality of substrates is thermally treated in the second batch processing system by heating the second plurality of substrates. The first plurality of substrates is removed from the first batch processing system, and the second plurality of substrates is concurrently removed from the second batch processing system. Thereafter, the first plurality of substrates is loaded into the second batch processing system, and the second plurality of substrates is loaded into the first batch processing system.

Although only certain embodiments of this invention have been described in detail above, those skilled in the art will readily appreciate that many modifications are possible in the embodiments without materially departing from the novel teachings and advantages of this invention. Accordingly, all such modifications are intended to be included within the scope of this invention.

What is claimed is:

1. A processing system for treating a plurality of substrates, comprising:
a first batch processing system configured to chemically treat said plurality of substrates;
a second batch processing system configured to thermally treat said plurality of substrates;
a transfer system coupled to said first batch processing system and said second batch processing system, and configured to transfer said plurality of substrates into and out of said first batch processing system and transfer said plurality of substrates into and out of said second batch processing system; and
a control system coupled to said first batch processing system, said second batch processing system and said transfer system, and configured to execute a chemical removal process, wherein said chemical removal process comprises chemically treating said plurality of substrates in said first batch processing system in order to chemically alter exposed surface layers on said plurality of substrates and thermally treating said plurality of substrates in said second batch processing system in order to elevate a temperature of the plurality of substrates and cause evaporation of said chemically altered exposed surface layers.

2. The processing system of claim 1, further comprising:
a substrate holder configured to support said plurality of substrates in said first batch processing system or said second batch processing system or both, wherein said plurality of substrates are aligned vertically and each of said plurality of substrates lies in a unique horizontal plane that is spaced vertically at an interval from an adjacent horizontal plane.

3. The processing system of claim 2, wherein said transfer system is configured to load said substrate holder with said plurality of substrates, and wherein said transfer system is configured to position said loaded substrate holder on a first elevator that is configured to elevate and seal said substrate holder with said first batch processing system or position said loaded substrate holder on a second elevator that is configured to elevate and seal said substrate holder with said second batch processing system.

4. The processing system of claim 1, further comprising:
a first substrate holder configured to support a first plurality of substrates, wherein said first plurality of substrates are aligned vertically and each of said first plurality of substrates lies in a unique horizontal plane that is spaced vertically at an interval from an adjacent horizontal plane;
a second substrate holder configured to support a second plurality of substrates, wherein said second plurality of substrates are aligned vertically and each of said second plurality of substrates lies in a unique horizontal plane that is spaced vertically at an interval from an adjacent horizontal plane;
a multi-holder transfer device located in said transfer system and configured to support said first substrate holder and said second substrate holder,
wherein said multi-holder transfer device is configured to align said first substrate holder with said first batch processing system and align said second substrate holder with said second batch processing system, and concurrently elevate and seal said first substrate holder with said first batch processing system and said second substrate holder with said second batch processing system.

5. The processing system of claim 4, wherein said multi-holder transfer device is configured to concurrently retract and unseal said first substrate holder with said first batch processing system and said second substrate holder with said second batch processing system, rotate to align said first substrate holder with said second batch processing system and align said second substrate holder with said first batch processing system, and concurrently elevate and seal said first substrate holder with said second batch processing system and said second substrate holder with said first batch processing system.

6. The processing system of claim 1, further comprising:
a first substrate holder positioned within said first batch processing system and configured to support said plurality of substrates, wherein said plurality of substrates are aligned vertically on said first substrate holder and wherein each of said plurality of substrates is aligned substantially parallel with one another and lies in a unique, vertically spaced horizontal plane;
a second substrate holder positioned within said second batch processing system and configured to support said plurality of substrates, wherein said plurality of substrates are aligned vertically on said second substrate holder and wherein each of said plurality of substrates is aligned substantially parallel with one another and lies in a unique, vertically spaced horizontal plane;
a multi-substrate transfer device located in said transfer system, and configured to receive said plurality of substrates and perform one or more of loading said plurality of substrates onto said first substrate holder in said first batch processing system or loading said plurality of substrates onto said second substrate holder in said second batch processing system.

7. The processing system of claim 6, wherein said multi-substrate transfer device comprises a substrate loading arm having a plurality of substrate blades, each of said plurality of substrate blades configured to receive one of said plurality of substrates and load said one of said plurality of substrates onto said first substrate holder or said second substrate holder.

8. The processing system of claim 6, wherein said multi-substrate transfer device comprises a first substrate loading arm having a first plurality of substrate blades, each of said first plurality of substrate blades configured to receive one of a first plurality of substrates and load said one of said first plurality of substrates onto said first substrate holder, and a second substrate loading arm having a second plurality of substrate blades, each of said second plurality of substrate blades configured to receive one of a second plurality of substrates and load said one of said second plurality of substrates onto said second substrate holder.

9. The processing system of claim 8, wherein said first substrate loading arm is configured to operate independently from said second substrate loading arm.

10. The processing system of claim 1, wherein said first batch processing system comprises a process gas injection system configured to introduce a process gas comprising as incipient ingredients HF and optionally ammonia (NH₃) to said first batch processing system.

11. The processing system of claim 1, wherein said first batch processing system comprises one or more temperature control elements configured to adjust the temperature of said plurality of substrates.

12. The processing system of claim 11, wherein said one or more temperature control elements are configured to adjust the temperature of said plurality of substrates to a value ranging from about 20 degrees C to about 100 degrees C.

13. The processing system of claim 11, wherein said one or more temperature control elements are configured to adjust the temperature of said plurality of substrates to a value ranging from about 25 degrees C to about 60 degrees C.

14. The processing system of claim 1, wherein said second batch processing system comprises a process gas injection system configured to introduce an inert gas to said second batch processing system.

15. The processing system of claim 14, wherein said inert gas comprises nitrogen (N₂) or a noble gas or both.

16. The processing system of claim 1, wherein said second batch processing system comprises one or more temperature control elements configured to adjust the temperature of said plurality of substrates.

17. The processing system of claim 11, wherein said one or more temperature control elements are configured to adjust the temperature of said plurality of substrates to a value greater than or equal to about 100 degrees C.

18. A method for treating a plurality of substrates, comprising:
loading a plurality of substrates into a first batch processing system using a transfer system;
chemically treating said plurality of substrates by exposing said plurality of substrates to a gas composition comprising as incipient ingredients HF and optionally ammonia (NH₃);
removing said plurality of substrates from said first batch processing system using said transfer system;
after said removing, loading said plurality of substrates into a second batch processing system using said transfer system; and
thermally treating said plurality of substrates by heating said plurality of substrates.

19. A method for treating a plurality of substrates, comprising:
loading a first plurality of substrates into a first batch processing system using a transfer system;
concurrently loading a second plurality of substrates into a second batch processing system using said transfer system;
chemically treating said first plurality of substrates by exposing said first plurality of substrates to a gas composition comprising as incipient ingredients HF and optionally ammonia (NH₃); and
thermally treating said second plurality of substrates by heating said second plurality of substrates.

20. The method of claim 19, further comprising:
removing said first plurality of substrates from said first batch processing system using said transfer system;
concurrently removing said second plurality of substrates from said second batch processing system using said transfer system;
loading said first plurality of substrates into said second batch processing system using said transfer system; and
loading said second plurality of substrates into said first batch processing system using said transfer system.
